(19) United States
(12) Patent Application Publication
(10) Pub. No.: US 2011/0182680 A1
(43) Pub. Date: Jul. 28, 2011

(54) Cutter and insert

(76) Inventor: Ilan Cohen, Shavey Zion (IL)

(21) Appl. No.: 12/929,113

(22) Filed: Jan. 3, 2011

Related U.S. Application Data
(60) Provisional application No. 61/336,391, filed on Jan. 22, 2010.

(51) Int. Cl. B23B 27/16; B23B 1/00

(52) U.S. Cl. 407/102; 82/1.11

(57) ABSTRACT

A cutter is provided with a releasably secured cutting insert nested in an insert pocket. The cutting insert is generally polygonal shaped in top view, and has a protrusion received in a recess formed in a cutter body. The cutter may be applied in turning, milling, boring and/or drilling, threading and/or chamfering, facilitating usage of one interchangeable insert tool as opposed to several, solid tools.

### CROSS-REFERENCE TO RELATED APPLICATIONS

This application claims priority to U.S. Provisional Patent Application Ser. No. 61/336,391, filed Jan. 22, 2010, titled “Cutter and Insert”.

### FIELD OF THE INVENTION

Disclosed is a cutter and a corresponding at least one insert, which may used, by way of example only, to be applied to a material, to machine away material chips leaving a desired shape or form.

### BACKGROUND OF THE INVENTION

Generally, cutters may be of several general types, including, but not necessarily limited to, solid cutters, and exchangeable tip cutters. Exchangeable tip cutters generally carry a benefit in that when worn, only tips (also known as bits, or inserts) need exchanging, while cutter bodies generally may have a rather long durability and/or service lives.

WO2008050318 discloses “An indexable tangential cutting insert (100) has a convex top surface (110), a bottom surface (112) provided with a cylindrical insert protrusion (136), and a peripheral side surface including a pair of opposing major side surfaces (116A, 116B) and a pair of opposing minor side surfaces (114A, 114B). A sloped, major cutting edge (122) is formed at the intersection of each major side surface (116) with the top surface (110), the rake surface being formed in the major side surface (122). The bottom surface (112) is provided with an insert protrusion abutment surface (134) for seating the cutting insert (100). An insert recess (154) is formed in the cylindrical insert protrusion (136), and this recess (154) communicates with the insert's through bore (180). The cutting insert (100) is seated in an insert pocket (206) with the insert protrusion abutment surface (134) in abutment with the pocket base. A protrusion (284) rising from the pocket base and having a threaded bore (280) formed therein enters the recess (154) and is aligned with the insert's through bore (180).”

EP0551540 discloses, inter alia, “A milling tip (5) has a central hole (8) through which a fastening bolt (4) passes which is pre-tensioned at its rear end in a shank (1) so that the milling tip (5) is clamped in position at the end face of a shank sleeve (2). In the area of the milling tip (5) and the adjoining front end (9) of the shank sleeve (2), the fastening bolt (4) has a cross-section in the form of a regular convex polygon. The blind hole (8) and the adjoining passage section of the front end (9) of the sleeve have complementary cross-sections so that the milling tip (5) is fastened via the fastening bolt (4) to the shank sleeve (2) in such a way as to be locked against rotation.”

U.S. Pat. No. 4,461,602 discloses, inter alia, “ . . . A milling cutter consists of a shaft 10, a cutter plate 12 and a screw bolt 14 by means of which the cutter plate 12 is detach-ably fastened at the front end of the shaft 10. The latter has a recess in the front face thereof. The recess is defined by three planar side faces leaving a peripheral gap between each pair thereof. The cutter plate substantially formed triangularly is fitted in the recess for being immovable in a radial plane. Protrusions 30 of the cutter plate protrude through the gaps and are provided with a cutting edge respectively.”

U.S. Pat. No. 5,607,263 discloses, inter alia, “ . . . A cutting tool having a cutting plate with at least one blade and a central axial hole through which a head screw can be used to connect the cutting plate to a holder having an axial bore through its center for receiving the screw and a recess around the bore for receiving a complimentary projection located around the central hole of the cutting plate which is longer than the recess is deep. Alternate embodiments are provided in which the projection is located on the holder and the recess in the face of the cutting plate. In all embodiments, the recess and projection have contacting surfaces which substantially eliminate axial forces on the head screw.”

It would be desirable to have an exchangeable tip cutter capable of repeatedly introducing a cutting tip of an insert to a work-piece with as little positional variance as possible even when indexing and/or exchanging the insert. This may be attained with the subject matter in accordance with the claims.

### SUMMARY OF THE INVENTION

In the following disclosure, aspects thereof are described and illustrated in conjunction with systems and methods which are meant to be exemplary and illustrative, not limiting in scope.

The present disclosure is broadly related to a cutter designed for machining operations, and more specifically in multiple machining operations in a single setting, and to a method associated with the aforementioned cutter.

According to an aspect of the present disclosure, there is provided a cutter comprising a cutter body extending generally axially along a longitudinal axis L having a forwardly disposed cutting portion comprising an at least one replaceable cutting insert releasably secured thereto. The cutting portion comprises a corresponding at least one insert pocket, itself comprising a lower support surface having at least one stopper generally axially extending away from the lower support surface, and a generally cylindrical recess extending downwardly away from the lower support surface. The at least one cutting insert comprises an intermediate abutment surface and a peripheral surface having at least one side abutment surface, and a generally cylindrical protrusion extending downwardly from the intermediate abutment surface. The at least one cutting insert may be removably secured to the cutting portion of the cutter body, with the intermediate abutment surface abutting the lower support surface, with the protrusion slidingly fit in the recess, and with the at least one stoppers abutting the least one side abutment surface.

Possibly, the cutter may be capable of performing multiple machining operations of turning, milling, drilling, boring, threading and chamfering. Further possibly, the multiple machining operations may be carried-out in a single setting of the cutter.

Optionally, the at least one cutting insert has a generally polygonal shape in a top view.

Further optionally, the protrusion comprises an axial extent E as measured from the intermediate abutment surface to a bottom surface.

Possibly, the extent E comprises a considerable proportion of an overall height H of the at least one cutting insert as measured between an upper surface and the bottom surface.

Potentially, the upper surface of the at least one cutting insert comprises a sunken depression formed therein, dipping from the upper surface to a depression floor.

Further possibly, the sunken depression at the upper surface facilitates machining to the entire extent of a blind bore which may be formed in a work-piece, or threading the entire extent of a bore, or ramp-down, or face, slot, and plunge operations.

Potentially, the at least one cutting insert comprises an at least one addendum extending generally radially in a direction away from a through bore generally centrally disposed about the longitudinal axis L, and merges with an insert main body.

Possibly, the at least one cutting insert may be removably secured to the cut-ting portion of the cutter body by means of a fastener.

Potentially, the fastener passes through a through bore generally centrally formed in the at least one cutting insert about the longitudinal axis L formed and through the protrusion.

Further potentially, the fastener engages a bore formed in the recess of the at least one insert pocket.

Optionally, the fastener comprises an axially forwardly disposed frusto-conical head and a stem extending generally axially rearwardly away therefrom.

Further optionally, tensioning the fastener assists in stabilizing the at least one cutting insert by virtue of the extent E of the protrusion.

Possibly, when removably installed in the cutter body, there exists a small gap between an outer envelope of the protrusion and a peripheral wall of the recess along the entire extent E of the protrusion.

According to another aspect of the present disclosure, an exemplary method of performing a plurality of machining operations in a single setting of the cutter may be employed. According to such an exemplary method, there is provided a cutter comprising a cutter body having a cutting portion with a replaceable cutting insert releasably secured thereto; providing a work-piece; feeding the cutter into the work-piece or vice verse; feeding the cutter sideways to machine away material off the work-piece to form a bore, and removing the cutter from the workpiece, leaving off a formed bore.

Possibly, the method further comprises a step of providing a siding fit between the protrusion and the recess, along an entire extent E of the protrusion accommodated in the recess.

Potentially, the sliding fit, together with a tension exerted by the head of the fastener on the removably installed at least one insert and the cutter body facilitates to stability and repeatability of the removably installed at least one insert on the cutter body.

In addition to the exemplary aspects and embodiments described above, fur-ther aspects and embodiments will become apparent by reference to the figures and by study of the following detailed descriptions.

### BRIEF DESCRIPTION OF DRAWINGS

Exemplary embodiments are illustrated in referenced figures and drawings. It is intended that the embodiments and figures disclosed herein are to be considered illustrative rather than restrictive.

Reference will now be made to the accompanying drawing, in which:

FIG. 1 schematically illustrates an exploded perspective view of a cutter with a removably secured cutting insert;

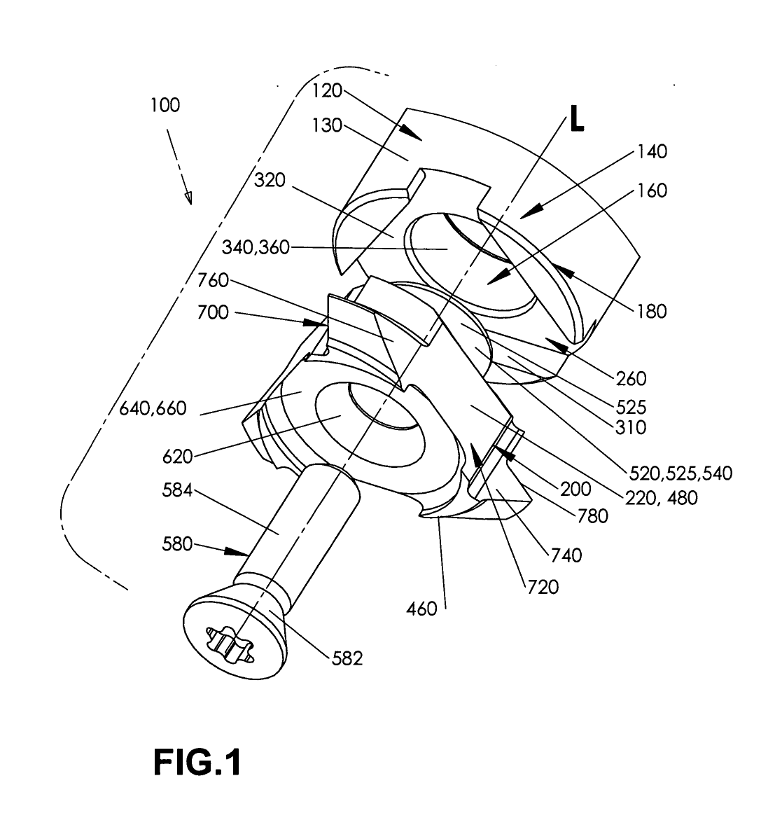

FIG. 2 schematically illustrates a longitudinal cross-section of the cutter shown in FIG. 1, taken along a longitudinal axis L;

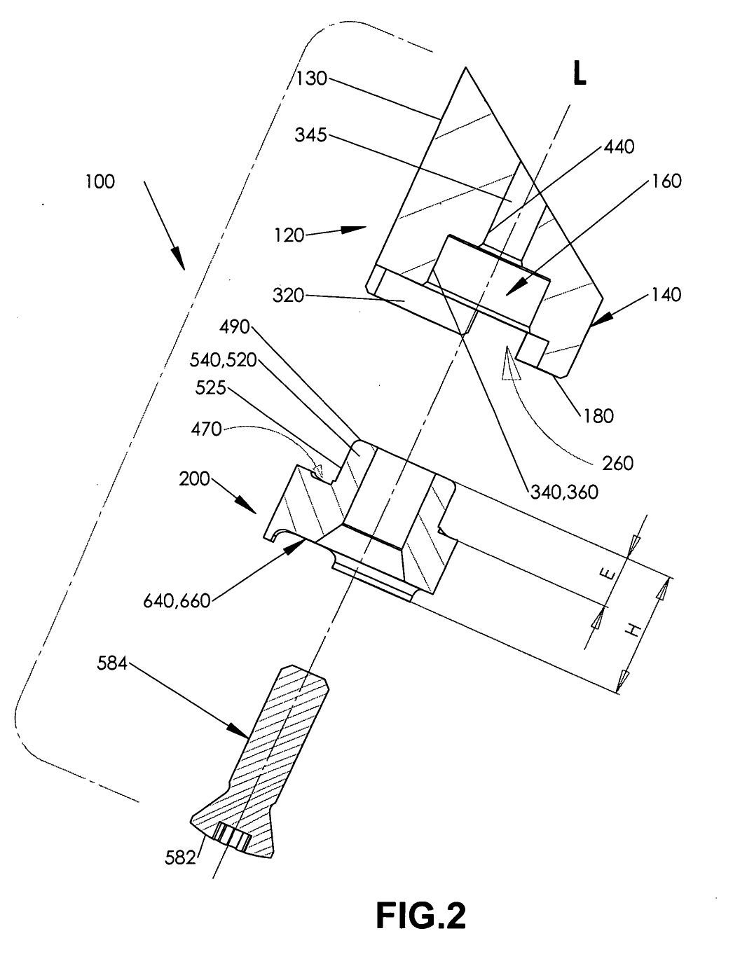

FIG. 3 schematically illustrates a perspective view of an assembled cutter shown in FIG. 1; and

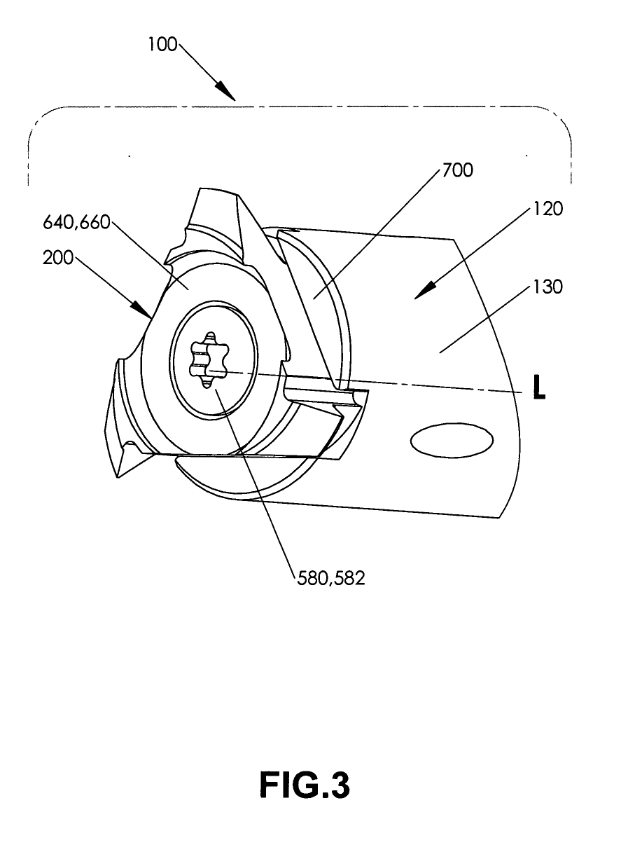

FIG. 4 schematically illustrates a longitudinal cross section of the assembled cutter shown in FIG. 3, taken along the longitudinal axis L.

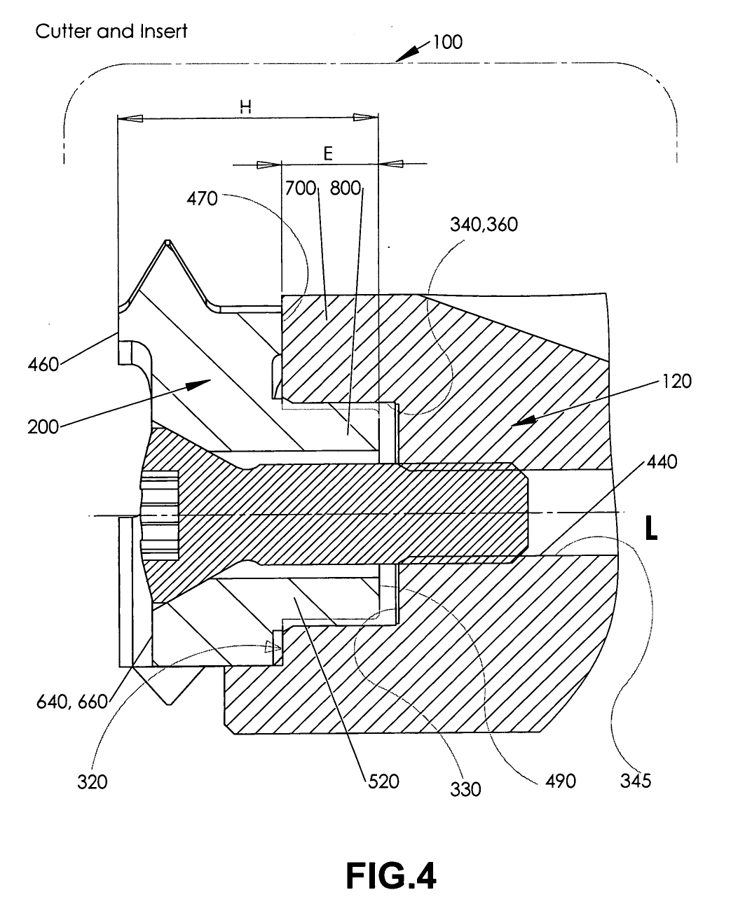

### DETAILED DESCRIPTION

Attention is drawn to the Figures. A cutter 100 is generally designed for machining operation (see, as a non-binding illustrative example, http://en.wikipedia.org/wiki/Machining, or http://en.wikipedia.org/wiki/Cutting_tool_(machining)) and which may be capable of either linear and/or rotary machining operations, such as, but not limited to, turning, drilling and/or boring, milling, threading and/or chamfering. Such a cutter 100 may generally comprise a cutter body 120 having a peripheral envelope 130, and a rear shank 140 extending generally axially rearwardly along a longitudinal axis L away from a cutting portion 160 axially forwardly disposed adjacent a front face 180 of the cutter body 120. The cutting portion 160 accommodates at least one replaceable and indexable cutting insert 200 releasably secured thereto, in a corresponding, at least one insert pocket 260 formed in the cutting portion 160 of the shank 140. Such cutting inserts are generally, as an illustrative example, manufactured of any known or discovered materials and/or compositions. Further, such cutting inserts may be either uncoated, or coated with any known or discovered, appropriate coating.

The at least one insert pocket 260 comprises a lower support surface 320 which may be shaped to correspond with the at least one cutting insert 200. The lower support surface 320 may have at least one, axially forwardly extending, upstanding stopper 310 disposed about the insert pocket 260, and a recess 340 extending downwardly from the lower support surface 320. The recess 320 has a circular axial cross-section (not shown). The recess 340 comprises a peripheral wall 360 extending between the support surface 320 and a base surface 330 of the recess 340. The base surface of the recess 340 may be provided with a bore 440. The bore 440 may be internally threaded.

The at least one cutting insert 200 has a generally polygonal shape in a top view. Such polygonal shapes may include, but are not limited to, triangles, squares and/or rectangles or rectangular shapes, parallelogram and/or rhomboid and/or rhombus shapes, regular or irregular hexagon shapes, and/or rounded or circular shapes. The at least one cutting insert 200 comprises an upper surface 460, an axially rearwardly facing intermediate abutment surface 470 and a peripheral surface 220 extending therebetween. The peripheral surface 220 comprised at least one side abutment surface 480. A protrusion 520, comprises a generally cylindrical shape, and extends away from the intermediate abutment surface 470 to a bottom surface 490. The protrusion 520 has a generally cylindrical outer envelope 525 and an axial extent E as measured from the intermediate abutment surface 470 to the bottom surface 490. The extent E comprises a considerable proportion of an overall height H of the at least one cutting insert 200 between the upper surface 460 and the bottom surface 490.

The upper surface 460 of the cutting insert 200 has a sunken depression 640 formed therein, dipping from the upper surface 460 to a depression floor 660 to facilitate machining to the entire extent of a blind bore which may be formed in a workpiece and/or threading the entire extent of a bore, and/or ramp-down and/or face, slot, and plunge operations.

The at least one cutting insert 200 may be provided with at least one addendum 700 extending generally radially in a direction away from a through bore 620 extending axially through the insert 200 and merges with an insert main body 720. The at least one addendum 700 has a tangentially forward facing rake face 740 and a generally a tangentially rearward facing back face 760. The rake face 740 may define a peripheral cutting edge 780. However, actual and/or specific shape of the at least one addendum 700 may vary according to application. As a schematic, non-binding illustrative example, such shapes and/or uses may include, but not be limited to, turning, milling (including, as a non binding, illustrative examples, blind and/or through-boring and/or drilling and/or threading the entire extent of a bore and/or chamfering a bore or a through-bore, and/or ramp-down and/or face, slot, or plunge operations and/or turning operations. These, and other operations, may be carried-out in a single setting of the cutter 100.

When the cutting insert 200 is releasably secured in the insert pocket 260, the intermediate abutment surface 470 of the at least one cutting insert 200 abuts the support surface 320 of the insert pocket 260 in the cutting portion 160. The at least one stopper 310 abuts the at least one side abutment surface 480, to provide some support against rotation of the at least one cutting insert 200 in the corresponding at least one insert pocket 260. The at least one addendum 700 extends generally radially away and beyond the peripheral envelope 130 of the cutter body 120.

The abutment surface 470 of at least one cutting insert 200 may comprise an axially-rearwardly facing abutment sole 475 associated with the at least one addendum 700 to better support the at least one cutting insert 200 on the cutter body 110.

With the at least one cutting insert 200 removably secured in the at least one insert pocket 260 of the cutter body 120, the protrusion 520 slidingly fits the recess 340. The cutting insert 200 may optionally be secured to the cutting portion 160 of the cutter body 120, possibly by means of a pin and/or a fastener 580 which may pass through a through bore 620 optionally formed in the cutting insert 200 and through the protrusion 520, and may engages the bore 440 formed in the recess 340 of the insert pocket 260 and thus may assist in securing the insert 200 to the cutter body 120. The pin and/or a fastener 580 may have an axially forwardly disposed frusto-conical head 582 and a stem 584 extending generally axially rearwardly away therefrom. The stem 584 may be externally threaded. Tensioning the pin and/or a fastener 580 may assist in stabilizing the at least one cutting insert 200 by virtue of the extent E of the protrusion 520. However, other releasably securing and/or centring means may be employed, including, as a non-binding illustrative ex-ample, but not limited to, a bayonet connection. When removably installed, the at least one cutting insert 200, there may be a small gap 800 between the outer envelope 525 of the protrusion 520 and the peripheral wall 360 of the recess 340 along the entire extent E of the protrusion 520.

The siding fit between the protrusion 520 and the recess 340, and the extent E of the protrusion 520 accommodated in the recess 340, together with the tension exerted by the head 582 of the fastener 580 on the removably installed at least one insert 200 and the cutter body 120, contribute to the stability and repeatability on the removable installation of the at least one insert 200 on the cutter body 120.

Further, disclosed is a method for performing several operations in a single setting of a cutter. The method includes the steps of providing a cutter comprising a cutter body having a cutting portion with a replaceable cutting insert releasably secured thereto, providing a work-piece, feeding the cutter into the workpiece or vice verse, feeding the cutter sideways to machine away material off the work-piece to form and/or to expand a bore, removing the cutter from the workpiece, leaving off a formed bore, and potentially feeding again the cutter into the material and sideways to form, for illustrative example only, a chamfer about an edge of the formed bore. The method further comprises a step of providing a siding fit between the protrusion and the recess, along an entire extent E of the protrusion accommodated in the recess. Potentially, the sliding fit, together with a tension exert-ed by the head of the fastener on the removably installed at least one insert and the cutter body facilitates to stability and repeatability of the removably installed at least one insert on the cutter body.

All directional references (such as, but not limited to, upper, lower, upward, downward, left, right, leftward, rightward, top, bottom, above, below, vertical, horizontal, clockwise, and counter-clockwise, tangential, axial and/or radial, or any other directional and/or similar references) are only used for identification purposes to aid the reader's understanding of the embodiments of the present disclosure, and may not create any limitations, particularly as to the position, orientation, or use unless specifically set forth in the claims. Similarly, joinder references (such as, but not limited to, attached, coupled, connected, and the like) are to be construed broadly and may include intermediate members between a connection of elements and relative movement between elements. As such, joinder references may not necessarily infer that two elements are directly connected and in fixed relation to each other.

In some instances, components are described with reference to “ends” having a particular characteristic and/or being connected with another part. However, those skilled in the art will recognize that the present disclosure is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

Similarly, adjectives such as, but not limited to, “articulated”, “modified”, or similar, should be construed broadly, and only as nominal, and may not create any limitations, not create any limitations, particularly as to the description, operation, or use unless specifically set forth in the claims.

While the entire discussion relates to a seated position as a first position, and to a prone position as a second position, the opposite may equally apply, that is, the patient may be initially positioned in the prone position, and transferred passively to the seated position. Additionally, the patient may be positioned on the therapeutic apparatus in any interim position, and transferred substantially passively to any other position, either any interim position between the seated and prone positions, or the first and second positions themselves.

In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure as set forth in the claims. It is intended that all matter contained in the above description or shown in the accompanying drawings shall be interpreted as illustrative only and not limiting. Changes in detail or structure may be made without departing from the spirit of the present disclosure as defined in the appended claims.

While a number of exemplary aspects and embodiments have been discussed above, and/or described or shown in the accompanying drawings, it is to be understood that such embodiments are merely illustrative of and not restrictive on the broad present disclosure, and that this present disclosure not be limited to the specific constructions and arrangements shown and described, since various other modifications and/or adaptations may occur to those of ordinary skill in the art. It is to be understood that individual features shown or described for one embodiment may be combined with individual features shown or described for another embodiment. It is to be understood some features are shown or described to illustrate the use of the present disclosure in the context of functional elements and such features may be omitted within the scope of the present disclosure and without departing from the spirit of the present disclosure as defined in the appended claims.

1. A cutter comprising a cutter body extending generally axially along a lon-gitudinal axis L having a forwardly disposed cutting portion comprising an at least one replaceable cutting insert releasably secured thereto, the cutting portion having a corresponding at least one insert pocket comprises a generally radially-extending lower support surface having at least one stopper generally axially extending forwardly away from the lower support surface, and a generally cylindrical recess extending generally axially rearwardly away from the lower support surface, the at least one cutting insert comprises a generally radially extending intermediate abutment surface and a peripheral surface extending generally transversely thereto and having at least one side abutment surface, with a generally cylindrical protrusion extending generally axially downwardly from the intermediate abutment surface so that the at least one cutting insert may be removably secured to the cutting portion of the cutter body, with the intermediate abutment surface abutting the lower support surface, with the protrusion slidingly fit in the recess, and with the at least one stoppers abutting the least one side abutment surface.

2. The cutter of claim 1, wherein the cutter being capable of performing multiple machining operations of turning, milling, drilling, boring, threading and chamfering.

3. A method for performing several operations on a single setting of a cutter, wherein the method includes:
a. providing a cutter comprising a cutter body having a cutting portion with a replaceable cutting insert releasably secured thereto;
b. providing a work-piece;
c. feeding the cutter into the work-piece or vice verse;
d. feeding the cutter sideways to machine away material off the work-piece to form a bore;
e. removing the cutter from the work-piece, leaving off a formed bore.

4. The cutter of claim 1, wherein the at least one cutting insert has a generally polygonal shape in a top view.

5. The cutter of claim 1, wherein the protrusion comprises an axial extent E as measured from the intermediate abutment surface to a bottom surface.

6. The cutter of claim 5, wherein the extent E comprises a considerable pro-portion of an overall height H of the at least one cutting insert as measured between an upper surface and the bottom surface.

7. The cutter of claim 6, wherein the upper surface of the at least one cutting insert comprises a sunken depression formed therein, dipping from the upper surface to a depression floor.

8. The cutter of claim 7, wherein the sunken depression at the upper surface facilitates machining to the entire extent of a blind bore which may be formed in a work-piece, or threading the entire extent of a bore, or ramp-down, or face, slot, and plunge operations.

9. The cutter of claim 1, wherein the at least one cutting insert comprises an at least one addendum extending generally radially in a direction away from a through bore generally centrally disposed about the longitudinal axis L, and merges with an insert main body.

10. The cutter of claim 2, wherein the machining operations may be carried out in a single setting of the cutter.

11. The cutter of claim 1, wherein the at least one cutting insert is removably secured to the cutting portion of the cutter body by means of a fastener.

12. The cutter of claim 11, the fastener passes through a through bore generally centrally formed in the at least one cutting insert about the longitudinal axis L formed and through the protrusion.

13. The cutter of claim 12, wherein the fastener engages a bore formed in the recess of the at least one insert pocket.

14. The cutter of claim 13, wherein the fastener comprises an axially forwardly disposed frusto-conical head and a stem extending generally axially rearwardly away therefrom.

15. The cutter of claim 14, wherein tensioning the fastener assists in stabilizing the at least one cutting insert by virtue of the extent E of the protrusion.

16. The cutter of claim 14, wherein when removably installed in the cutter body, there exists be a small gap between an outer envelope of the protrusion and a peripheral wall of the recess along the entire extent E of the protrusion.

17. The cutter of claim 1, wherein the abutment surface of at least one cutting insert comprises an axially rearwardly facing abutment sole associated with the at least one addendum to better support the at least one cutting insert on the cutter body.

18. The method of claim 3, wherein the method further comprises a step of pro-viding a siding fit between the protrusion and the recess, along an entire extent E of the protrusion accommodated in the recess.

19. The method of claim 17, wherein the sliding fit, together with a tension exerted by the head of the fastener on the removably installed at least one insert and the cutter body facilitates to stability and repeatability of the removably in-stalled at least one insert on the cutter body.
